(19) United States
(12) Patent Application Publication
(10) Pub. No.: US 2026/0046538 A1
(43) Pub. Date: Feb. 12, 2026

(54) CENTRALIZED TESTING OF OPTICAL TRANSPORT SYSTEMS

(71) Applicant: CenturyLink Intellectual Property LLC, Denver, CO (US)

(72) Inventors: Paul M. Johnson, Littleton, CO (US); Jeffrey O'Day, Highlands Ranch, CO (US)

(73) Assignee: CenturyLink Intellectual Property LLC, Denver, CO (US)

(21) Appl. No.: 19/242,140

(22) Filed: Jun. 18, 2025

Related U.S. Application Data
(60) Provisional application No. 63/680,794, filed on Aug. 8, 2024.

(51) Int. Cl. H04Q 11/00; H04B 10/079

(52) U.S. Cl. CPC H04Q 11/0062; H04B 10/079; H04Q 2011/0083

(57) ABSTRACT

An optical test system includes a set of optical test sets configured to test a set of optical transport systems (e.g., optical networking systems that include fiber optic cables, optical multiplexer/demultiplexers, wave-selectable switches, and optical amplifiers. The optical test sets and optical transport systems are connected to an optical cross-connect device that is configured to switch connections between the test sets and the transport systems. A test manager maintains an inventory of optical tests, optical test sets, and optical transport systems. A remote computing device can access each of these devices via an IP network and can instruct the test manager to execute a particular optical test on a particular optical transport system. In response to receiving the instruction, the test manager causes the optical cross-connect device to connect the appropriate optical test set to the appropriate optical transport system and causes the optical test to be executed.

### CROSS-REFERENCE TO RELATED APPLICATIONS

This application claims the benefit of U.S. Provisional Application No. 63/680,794 filed Aug. 8, 2024, entitled “Centralized Testing of Optical Transport Systems,” which is incorporated herein by reference in its entirety.

### BACKGROUND

An optical transport system provides network communication capabilities via fiber optic cables and optical switches, among other hardware components. The performance of an optical transport system may be assessed using optical test sets that include algorithms and hardware for testing the optical transport system. It is with respect to this general technical environment that aspects of the present disclosure are directed.

### SUMMARY

The present application describes a system that includes: a first optical test set, communicatively connected to an Internet Protocol (IP) network and including: a first light source; a first optical power measurement system; a first processing unit; and first memory, operatively connected to the first processing unit and storing instructions that, when executed by the first processing unit, cause the first optical test set to execute a first optical test; a second optical test set, communicatively connected to the IP network and including: a second light source; a second optical power measurement system; a second processing unit; and second memory, operatively connected to the second processing unit and storing instructions that, when executed by the second processing unit, cause the second optical test set to execute a second optical test; an optical cross-connect device coupled with the first optical test set, the second optical test set, a first optical transport system, and a second optical transport system, wherein the optical cross-connect, the first optical transport system, and the second optical transport system are communicatively connected to the IP network; a test manager, communicatively connected to the IP network and including: a third processing unit; and third memory, operatively connected to the third processing unit and storing instructions that, when executed by the third processing unit, cause the test manager to: receive, via the IP network from a computing device, a request to execute the first optical test on the first optical transport system using the first optical test set; and in response to receiving the request: cause the optical cross-connect device to connect the first optical test set with the first optical transport system, and cause the first optical test set to execute the first optical test.

In some examples, the third processing unit is further configured to: receive, from the first optical test set, a result of the first optical test; and provide the result to the computing device.

In some examples, the third processing unit is further configured to: detect a completion of the first optical test; and in response to detecting the completion of the first optical test: obtain, from the first optical transport system, an alarm notification associated with the first optical test, and provide the alarm notification to the computing device.

In some examples, the third processing unit is further configured to: receive, via the IP network from the computing device, a second request to execute the second optical test on the second optical transport system using the second optical test set; in response to receiving the second request, identify a status of the second optical test set; in response to determining, based on the status, that the second optical test set is available: cause the optical cross-connect device to connect the second optical test set with the second optical transport system, and cause the second optical test set to execute the second optical test; and in response to determining, based on the status, that the second optical test set is unavailable, delay causing the optical cross-connect device to connect the second optical test set with the second optical transport system until the second optical test set is available.

In some examples. the third processing unit is further configured to: in response to determining that the second optical test set is unavailable, identify a completion time of the second optical test based on a duration associated with the second optical test; detect that the completion time has arrived; and in response to detecting that the completion time has arrived: cause the optical cross-connect device to connect the first optical test set with the second optical transport system, and cause the first optical test set to execute the first optical test.

In some examples, identifying the completion time includes obtaining the completion time from an inventory of optical test sets based on an identifier of the first optical test.

In some examples, the third processing unit is further configured to: in response to determining that the second optical test set is unavailable, monitor the second optical test set for a completion of the optical test; detect the completion of the second optical test; and in response to detecting that the completion of the second optical test: cause the optical cross-connect device to connect the second optical test set with the second optical transport system, and cause the second optical test set to execute the second optical test.

In some examples, detecting the completion of the first optical test includes receiving, from the second optical test set, a result of the second optical test.

In some examples, the third processing unit is further configured to: in response to detecting the completion of the first optical test, update a status of the first test set in an inventory to indicate that the first optical test set is available.

In some examples. the third processing unit is further configured to: in response to causing the first optical test set to execute the first optical test, updating a status of the first optical test set in the inventory to indicate that the first optical test set is in use.

The present application describes a method that includes: receiving, via an Internet protocol (IP) network from a remote computing device, a request to execute a first optical test on a first optical transport system using a first optical test set; and in response to receiving the request: causing an optical cross-connect device to connect the first optical test set with the first optical transport system, and causing the first optical test set to execute the first optical test; receiving, from the first optical test set, a result of the first optical test; and providing the result to the remote computing device.

In some examples, the method further includes: detecting a completion of the first optical test; and in response to detecting the completion of the first optical test: obtaining, from the optical transport system, an alarm notification associated with the first optical test, and providing the alarm notification to the computing device.

In some examples, the method further includes: receiving, via the IP network from a computing device, a second request to execute a second optical test on a second optical transport system using the second optical test set; in response to receiving the second request, identifying a status of the second optical test set; in response to determining, based on the status, that the second optical test set is available: causing the optical cross-connect device to connect the second optical test set with the second optical transport system, and causing the second optical test set to execute the second optical test; and in response to determining, based on the status, that the second optical test set is unavailable, delaying causing the optical cross-connect device to connect the second optical test set with the second optical transport system until the second optical test set is available.

In some examples, the method further includes: in response to determining that the second optical test set is unavailable, identifying a completion time of the second optical test based on a duration associated with the second optical test; detecting that the completion time has arrived; and in response to detecting that the completion time has arrived: causing the optical cross-connect device to connect the second optical test set with the second optical transport system, and causing the second optical test set to execute the second optical test.

In some examples, identifying the completion time includes obtaining the completion time from an inventory of optical test sets based on an identifier of the second optical test set.

In some examples, the method further includes: in response to determining that the second optical test set is unavailable, monitoring the second optical test set for a completion of the second optical test; detecting the completion of the second optical test; and in response to detecting that the completion of the second optical test: causing the optical cross-connect device to connect the second optical test set with the second optical transport system, and causing the second test set to execute the second optical test.

In some examples, detecting the completion of the second optical test includes receiving, from the second optical test set, a result of the second optical test.

The present application describes a system that includes: at least one processor; and
a memory including instructions, which when executed by the at least one processor, cause the system to: obtain, from an inventory, a list of optical tests and a list of optical transport systems; display, via a computing device, the list of optical tests and the list of optical transport systems; receive, via the computing device, one or more user inputs indicating selection of a first optical test of the list of optical tests and a first optical transport system of the list of optical transport systems; connect, using an optical cross-connect device and in response to receiving the one or more user inputs, a first optical test set with the first optical transport system; and cause the first optical test set to execute the first optical test.

In some examples, the instructions further cause the system to: receive, via the computing device, one or more second user inputs indicating selection of a second optical test of the list of optical tests and a second optical transport system of the list of optical transport systems; connect, using the optical cross-connect device and in response to receiving the one or more second user inputs, a second optical test set with the second optical transport system; and cause the second optical test set to execute the second optical test.

In some examples, the instructions further cause the system to: detect the completion of the first optical test; and in response to detecting the completion of the first optical test: update a status of the first optical test set in the inventory to indicate that the first optical test set is available, obtain, from the first optical transport system, a first result of the first optical test generated by the first optical transport system during the first optical test, obtain, from the first optical test set, a second result of the first optical test, and provide, to the computing device, the first result and the second result.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an example test system according to aspects of the present application.

FIG. 2 is an example method for testing an optical transport system according to aspects of the present application.

FIG. 3 is another example method for testing an optical transport system according to aspects of the present application.

FIG. 4 is a block diagram of an example computing system that can be employed in relation to the present application.

### DETAILED DESCRIPTION

Optical transport systems provide optical networking via fiber optic cables and optical switches, among other hardware components. The compliance of an optical transport system with particular communication protocols (e.g., protocols established by various standards bodies, such as the International Telecommunication Union, or ITU) may be evaluated using optical test sets that are configured to execute protocol-specific optical tests.

Executing an optical test on an optical transport system can yield diagnostic information related to performance monitoring metrics, alarm reporting and fault propagation, protection switching (e.g., rerouting when a network component fails), protocol overhead signal transparency (e.g., accurate processing of packet header or control information in addition to payload), bit error rate testing (BERT), and/or Y.1564 and RFC2544 testing for Ethernet services, for example.

Each optical test set includes various hardware and software to execute a particular type of optical test on an optical network system. For example, an optical test set may include light sources, an optical power measurement system, and other hardware, along with a processing unit and software for executing the optical test. As such, each optical test set may be quite expensive, and their efficient use is important.

In some cases, an entity having multiple optical test sets may test multiple optical transport systems by manually (e.g., physically) connecting a fiber optic cable between a particular test set and a particular optical transport system and causing the optical test set to execute an optical test (e.g., by providing an input to a user interface of a computer connected to the test set). Each optical test set may have its own user interface, for example.

As described herein, an optical cross-connect device (also referred to herein as an optical cross-connect) that is connected to an IP network can be used to enable remote connection of optical test sets to optical transport networks, such as via a user interface displayed on a remote computing device. In some examples, an inventory system for tracking availability of optical test sets and/or optical tests is connected to the IP network and can be accessed by the remote computing device to choose a particular optical test for execution based on information that is stored in the inventory system. In some examples, the optical test sets themselves are also connected to the IP network and can be remotely instructed to execute an optical test. Results from such execution can be obtained by the remote computing device via the IP network. In some examples, the optical transport systems are also connected to the IP network and can be remotely accessed to obtain, for example, alarm information (such as an alarm notification that indicates whether the optical transport system suffered any faults during execution of the optical test).

In some examples, an optical testing system includes a test manager connected to the IP network. The test manager can access and maintain the inventory of test sets, connect selected test sets to selected optical transport systems, execute test sets, collect information generated by the execution of the test sets (such as test results and/or alarming information), and provide test reporting capabilities to a remote computing device.

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the figures can comprise one or more machines or devices that are operatively connected to cooperate in order to provide the described system functionality. The following detailed description is therefore not to be taken in a limiting sense.

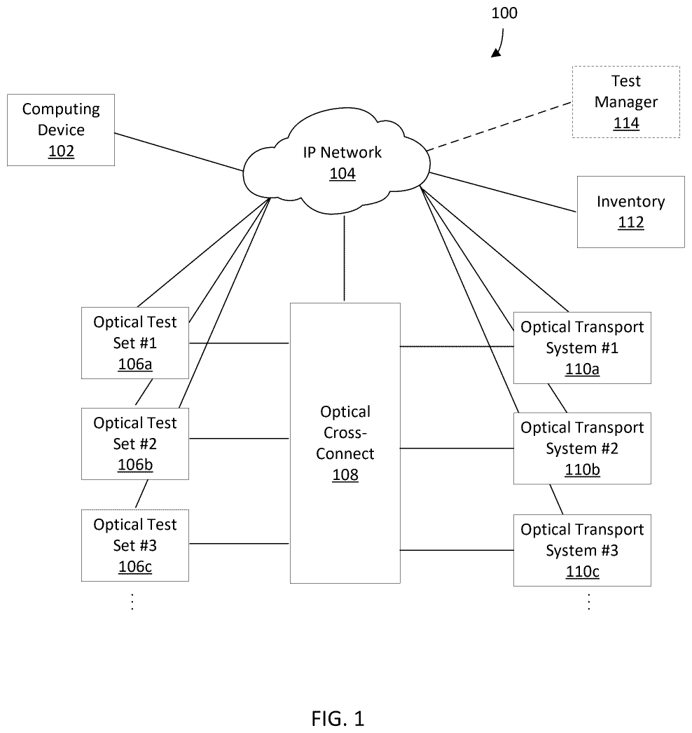

FIG. 1 depicts a nonexclusive example of an optical test system 100 for testing optical transport systems. Optical test system 100 includes a computing device 102, optical test sets 106a, 106b, and 106c (referred to collectively as optical test sets 106), an optical cross-connect 108, optical transport systems 110a, 110b, and 110c (referred to collectively as optical transport systems 110), and an inventory 112, each of which is connected to an Internet Protocol (IP) network 104. The computing device 102 can communicate, via the IP network 104, with the optical test sets 106, optical cross-connect 108, the optical transport systems 110), and the inventory 112 via the IP network 104.

The optical cross-connect 108 operates at the physical layer and includes hardware that is configured to switch optical signals between different ports of the optical cross-connect 108, such as an array of micro-electromechanical systems (MEMS) mirrors, liquid crystal switches, or other types of optical switching hardware.

The optical test sets 106 and optical transport systems 110 are each connected to ports of the optical cross-connect 108 to enable the optical cross-connect 108 to selectively connect optical test sets 106 to optical transport systems 110 for testing.

The optical transport systems 110 may each include various optical cables, optical multiplexers/demultiplexers, wave-selectable switches, optical amplifiers, and/or other optical devices for transceiving optical signals. In some examples, the optical transport systems 110 may each comprise a portion of one or more optical network(s).

As mentioned above, each optical test set 106 includes hardware and software for executing particular optical test(s) on an optical transport system 110. An optical test may be configured to test the compliance of an optical transport system 110 with one or more optical tests. Such optical tests can include tests for compliance with: one or more optical transport network (OTN) protocols, such as OTU2, OTU2e, OTU3, OTU4); one or more Ethernet protocols, such as 10GigE, 40GigE, 100GigE, 400GigE; one or more storage area network (SAN) protocols, such as 1G, 2G, 4G, 8G, 10G, 16G Fibre Channel; and/or one or more synchronous optical network (SONET) protocols, such as OC48 or OC192. The output of a particular optical test (e.g., a test executed by an optical test set 106) can include an indication of whether the optical transport system 110 passed or failed the test (which may be based on a user indication of acceptable performance parameters), an indication(s) of various performance monitoring metrics, an indication of the use, location, and/or effectiveness of protection switching (e.g., rerouting an optical signal when a network component fails), an indication of protocol overhead signal transparency (e.g., the accurate processing of packet header or control information in addition to the packet payload), an indication of the results of bit error rate testing (BERT), and/or an indication of the results of Y.1564 (an Ethernet service activation test) and/or RFC2544 testing (including, for example, throughput, latency, and/or frame rate) for Ethernet services. In some examples, an optical test set 106 outputs the results of an optical test via the IP network 104 such that the results are accessible to the computing device 102 via the IP network 104.

The inventory 112 is a database (e.g., stored in a storage device) that includes a list of each of the optical test sets 106 and/or corresponding optical tests that can be run by the optical test sets 106. In some examples, the inventory 112 includes a duration required by each of the optical tests and/or a usage status of each of the optical tests or optical test sets (e.g., an indication of whether the optical test set is in use or is available for testing). In some examples, the inventory 112 includes an indication of an expected availability date/time for each optical test set (e.g., a date/time at which the optical test set is expected to become available). In examples, the inventory 112 includes test set part numbers and serial numbers, test set management interface details (such as an IP address and/or management protocol associated with the test set), a connection to an optical cross-connect switch, a mapping of optical cross-connect switches to test sets and optical transport systems, and/or results of previously run optical tests. In examples, the inventory 112 can be accessed via an application program interface (API).

The optical test system 100 relieves the user of having to manually connect an optical test set 106 with an optical transport system 110 in order to execute an optical test(s). In operation, the computing device 102 may obtain a list of available optical tests (and/or optical test sets) from the inventory 112, and optionally additional information about each of the available optical tests and/or optical test sets (such as status, expected test duration, and/or expected availability date/time). For example, the inventory 112 may maintain status, duration, and/or expected availability information by detecting the initiation and/or completion of optical tests and/or by receiving such information via a user interface. In some examples, the list of available optical tests and/or optical test sets includes all of the optical tests and/or optical test sets stored in the inventory 112, regardless of whether any of the optical tests and/or optical test sets are currently in use. In some examples, the list of available optical tests and/or optical test sets includes optical tests and/or optical test sets that are not currently in use and are therefore available for immediate execution. Similarly, the computing device 102 may obtain a list of optical transport systems 110 from the inventory 112, which may also be associated with a status of “in use” or “available.”

The computing device 102 may display a user interface that includes the list of available optical tests and/or a list of available optical test sets and the list of optical transport systems 110 that are connected to the optical cross-connect 108. Optionally, the user interface includes additional information about each of the available optical tests and/or optical test sets (such as status, required duration, and/or expected availability). The computing device 102 may detect user inputs indicating selection of one or more optical test(s) and/or selection of an optical test set 106 configured to execute one or more optical tests, along with a selection of an optical transport system 110 on which to run the optical test(s). In response to receiving the user inputs, the computing device 102 may cause the optical cross-connect 108 to optically connect the selected optical test set 106 (or the optical test set 106 configured to execute the selected optical test(s)) with the selected optical transport system 110. In some examples, in response to receiving the user inputs and after connecting the optical test set with the optical transport system, the computing device 102 may cause an optical test set 106 (e.g., a selected optical test set 106 or a test set associated with one or more selected optical test(s)) to initiate execution of the one or more optical tests (e.g., one or more selected optical tests or one or more optical tests that a selected optical test set is configured to execute).

In some examples, the optical test system determines whether an optical test set and/or an optical transport system is/are available (e.g., by checking a status in the inventory of the optical test set and/or optical transport system) before causing the optical cross-connect to connect the selected optical test set with the selected optical transport system. If one or both of the selected optical test set and optical transport system have a status of “in use,” the optical testing system may delay causing the optical cross-connect to connect them until the optical testing system detects that the optical test set and optical transport system are available. For example, the optical test system may monitor a status of the optical test set and/or the optical transport system and may detect completion of the optical test, indicating availability of the optical test set. In some examples, if the optical test system determines, based on a status in the inventory 112 associated with the requested optical test set and/or a status in the inventory 112 associated with the requested optical transport system, that the requested optical test set and/or the requested optical transport system is unavailable, the optical test system may identify a completion date/time associated with the optical test. The optical test system may identify the completion date/time by adding a duration in the inventory 112 to a start date/time at which the optical test was initiated or by obtaining a completion date/time from the inventory 112. The optical test system may subsequently detect that the completion date/time has arrived (e.g., the current date/time matches the completion date/time), and in response, may cause the optical cross-connect 108 to connect the appropriate optical test set 106 to the appropriate optical transport system 110 and cause the optical test set to execute the optical test.

In other examples, the computing device 102 may receive a second user input requesting to initiate an optical test, and in response, the computing device 102 may cause an optical test set 106 to initiate execution of the selected optical test(s). In some examples, the computing device 102 may detect one or more user inputs indicating one or more test criteria associated with a selected optical test (e.g., criteria that must be satisfied in order for the optical transport system to pass the optical test).

In some examples, the optical test system 100 also includes a test manager 114 that provides additional scheduling and automation capabilities (shown with dashed lines in FIG. 1 to indicate that it is optional). The test manager 114 is connected to the IP network 104 and is configured to communicate with the computing device 102, the test sets 106, the optical cross-connect 108, the optical transport systems 110, and/or the inventory 112 (e.g., via the IP network 104). In some examples, the test manager 114 is configured to detect optical test sets 106 that are connected to the IP network and/or to detect optical transport systems 110 connected to the IP network 104 and automatically generate and/or update the inventory 112 with a list of detected optical test sets 106 and/or a list of detected optical transport systems 110. The test manager 114 may also detect optical connections between the test sets 106 and optical transport systems 110, such as by polling the optical cross-connect 108 to identify connections of optical test sets 106 and optical transport systems 110 on various ports of the optical cross-connect 108. In some examples, the test manager 114 maintains, in the inventory 112, a list of features associated with each of the optical test sets 106, such as a list of optical tests that can be executed by each test set 106, as not all optical test sets 106 may be capable of performing all optical tests.

The test manager 114 is configured to schedule and execute optical tests requested by a user of computing device 102 (and/or the user of another computing device). The test manager 114 may also generate and maintain a status of the optical test sets 106 and/or of the optical transport systems 110 (e.g., a status of available or in use) in the inventory 112 based on detecting a status of the optical test sets 106 and/or optical transport systems 110, and/or based on maintaining a log of optical test sets 106 that have been instructed, by the test manager 114, to execute an optical test(s) on an optical transport system 110. For example, the test manager 114 may detect (or cause) the initiation of an optical test (associated with an optical test set 106) to be executed on an optical transport system 110 and update a status of the optical test set 106 and optical transport system 110 in the inventory to indicate that the optical test set and optical transport system are in use (e.g., unavailable). The test manager 114 may detect the completion of the optical test and update the status of the corresponding optical test set and optical transport system in the inventory to indicate that the optical test set and optical transport system are available.

As an illustrative example, the test manager 114 may receive, from the computing device 102 (e.g., via a user interface displayed on the computing device 102), a request to execute an optical test(s) on a particular optical transport system 110. For example, the computing device 102 may obtain a list of optical tests, test sets, and/or optical transport systems from the inventory 112 and display one or more menus that allow the user to select an optical test and optical transport system from the inventory. The computing device 102 provides a test request including an indication of the selected optical test and an indication of the selected optical transport system to the test manager 114.

In response to receiving the test request, the test manager 114 identifies a corresponding optical test set 106 (e.g., a test set that is configured to execute the requested optical test) and determines whether the optical test set 106 is available. The test manager 114 may also determine whether the optical transport system 110 is available. If the optical test set 106 and the optical transport system 110 are available, the test manager 114 causes the optical cross-connect to connect the optical test set 106 to the optical transport system 110 and causes the optical test set 106 to initiate the requested optical test(s).

In some examples, the test manager 114 receives, as an input via a user interface displayed on the computing device 102, an input requesting a particular optical test. The test manager 114 identifies, based on the particular optical test, an optical test set 106 for executing the requested test. The test manager 114 generates one or more commands for the identified optical test set 106, where the commands instruct the optical test set 106 to execute the particular test. The test manager 114 provides the one or more commands to the optical test set 106 to cause the optical test set 106 to execute the particular optical test.

In some examples, the test manager 114 schedules and determines the order of tests to be performed on multiple optical transport systems 110 based on optical test set 106 availability and (in some cases) test duration. The test manager may determine the schedule and order to minimize the total amount of time required to execute all of the requested tests. For example, the test manager 114 may receive, via a user interface displayed on the computing device 102, a request to perform a first test, a second test, and a third test on each of a first set of optical transport systems. The test manager 114 may determine an order of the tests to be performed on each of the optical transport systems 110 based on the availability of optical test sets 106 configured to perform the first test, the second test, and/or the third test. (An optical test set is determined to be available if it is not currently in use and/or is not currently reserved for use.) The test manager 114 may schedule the requested tests based on the determined order of the tests and optionally, a pre-determined or estimated duration of the tests (which may be specified as a parameter for the test). For example, test manager 114 may cause the first test to be executed on a first optical transport system 110a using a first (available) optical test set 106a that is configured to execute the first test. The test manager may cause a second test to be executed on a second optical transport system 110b (e.g., in parallel with the first test) using a second (available) optical test set 106b that is configured to execute the second test. The test manager may cause the first test to be executed on a third optical transport system (e.g., in parallel with the first test on the first optical transport system and the second test on the second optical transport system) using a third (available) test set 106c that is also configured to execute the first test.

In response to determining that the first test on the first optical transport system 110a is complete, the test manager 114 may identify an optical test set 106 for executing the requested second test or the third test on the first optical transport system 110a. The identified optical test set 106 may be, for example, the first optical test set 106a (if it is also configured to execute the second optical test), the second optical test set 106b (assuming that the second test has completed on the second optical transport system 110b and the second optical test set 106b is available) or a different optical test set 106. The test manager may automatically (e.g., without user interaction) cause the optical cross-connect to couple the identified optical test set to the first optical transport system 110a and cause the second test or third test to execute on the first optical transport system 110a. Similarly, the test manager may automatically cause the additional requested tests to be run on the other optical transport systems 110 according to the determined schedule and order.

In some examples, the test manager 114 collects the results of the optical test(s) from the optical test set 106 and reports the results to the computing device 102 (or to another requesting computing device). In some examples, when the test manager causes the optical cross-connect to connect the optical test set 106 to the selected optical transport system 110, the test manager 114 updates a status of the optical test set 106 in the inventory 112 to indicate that the optical test set 106 is in use. In response to detecting that the optical test(s) is completed, the test manager 114 updates the status of the optical test set 106 in the inventory 112 to indicate that the optical test set 106 is available, and optionally requests alarm information from the optical transport system 110 that was tested. Such alarm information may include, for example, notifications related to faults experienced by the optical transport system during the optical test, such as optical power alarms, loss of signal alarms, loss of frame alarms, high bit error rate alarms, temperature alarms, or other types of alarms. The test manager 114 stores the alarm information and/or reports the alarm information to the computing device 102.

In some examples, the test manager 114 receives multiple requests to execute optical tests (e.g., multiple requests from a single computing device such as computing device 102 or multiple requests from multiple different computing devices) and schedules execution dates/times for the optical tests based on optical test set availability and/or optical test duration information obtained, by the test manager 114, from the inventory 112. The test manager 114 causes the optical test set(s) to execute the requested optical test(s) according to the schedule.

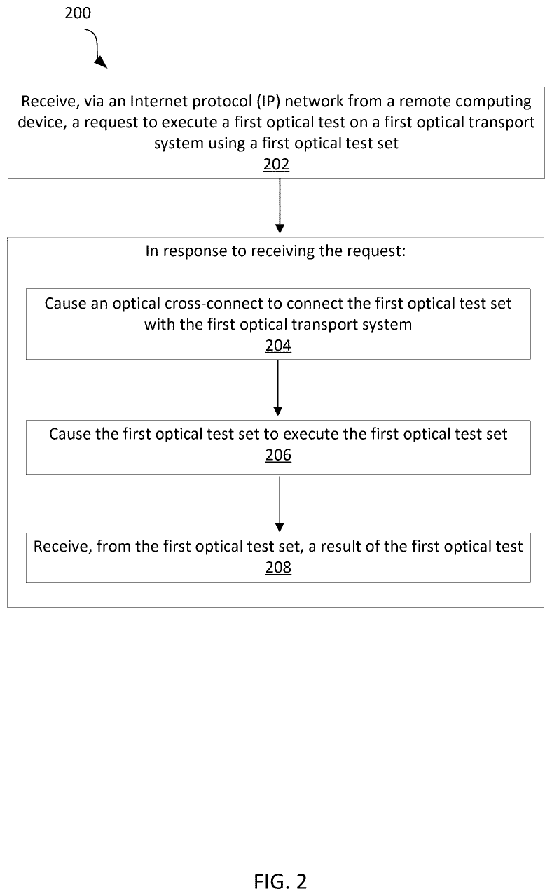

FIG. 2 depicts an example method 200 according to aspects of the present application. In examples, one or more of the operations of FIG. 2 can be performed by one or more components of an optical test system (e.g., singularly or collectively) such as optical test system 100.

At operation 202, the optical test system receives, via an IP network (e.g., IP network 104) from a remote computing device (e.g., computing device 102), a request to execute a first optical test on a first optical transport system (e.g., optical transport system 110) using a first optical test set (e.g., optical test set 106). In some examples, the computing device displays a list of one or more optical tests and a list of one or more optical transport system, and receives the request by detecting, via the computing device, one or more user inputs selecting the first optical test and the first optical transport system.

In response to receiving the request, the optical test system performs operations 204-208.

At operation 204, the optical test system causes an optical cross-connect (e.g., optical cross-connect 108) to connect the first optical test set with the first optical transport system. For example, a remote computing device (e.g., computing device 102) or a test manager (e.g., test manager 114) sends an instruction to the optical cross-connect to connect the first optical test set with the first optical transport system.

At operation 206, the optical test system causes the first optical test set to execute the first optical test. For example, a remote computing device (e.g., computing device 102) or a test manager (e.g., test manager 114) sends an instruction to the first optical test set to cause the first optical test set to execute the first optical test.

At operation 208. the optical test system receives, from the first optical test set (e.g., via the IP network 104), a result of the first optical test. For example, the test manager 114 or the computing device 102 receives the result of the first optical test. The result may include an indication of whether the first optical transport system passed or failed the first optical test or other information about the performance of the first optical transport system during the first optical test.

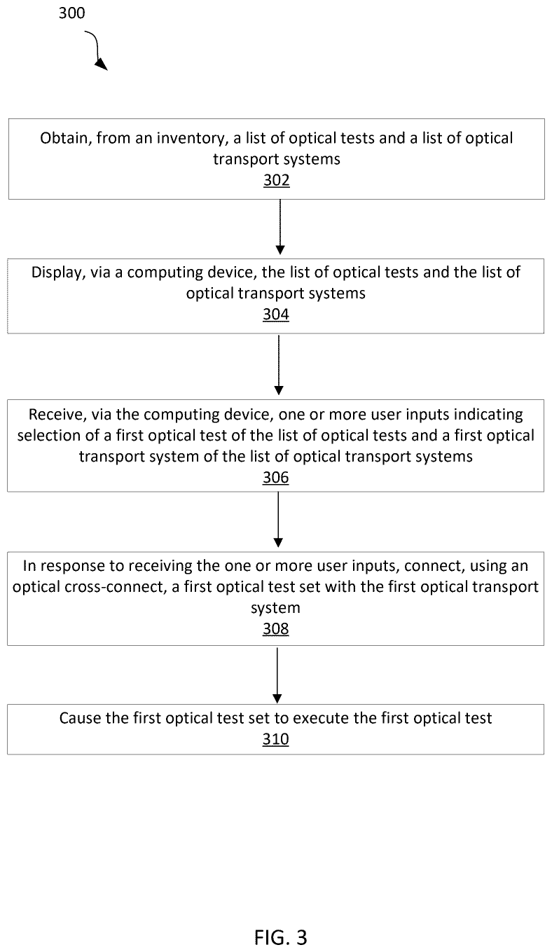

FIG. 3 depicts an example method 300 according to aspects of the present application. In examples, one or more of the operations of FIG. 3 can be performed by one or more components of an optical test system (e.g., singularly or collectively) such as optical test system 100.

At operation 302, the optical test system (e.g., a computing device 102 and/or a test manager 114 of the optical test system) obtains, from an inventory (e.g., inventory 112), a list of optical tests and a list of optical transport systems. In some examples, the list of optical tests includes all of the optical tests that are stored in the inventory, and/or the list of optical tests includes all of the optical tests that are stored in the inventory. In other examples, the list of optical tests includes those optical tests that are currently available (e.g., having a status, in the inventory, of “available”), and/or the list of optical transport systems includes those optical transport systems that are currently available (e.g., having a status, in the inventory, of “available”).

At operation 304, the optical test system displays, via a computing device (e.g., computing device 102), the list of optical tests and the list of optical transport systems. For example, the computing device may display, on a display of the computing device, the list of optical tests as a menu of selectable optical tests, and the list of optical transport systems as a menu of selectable optical transport systems.

At operation 306, the optical testing system receives, via the computing device, one or more user inputs indicating selection of a first optical test of the list of optical tests and a first optical transport system of the list of optical transport systems. The user inputs optionally also include testing parameters associated with the first optical test, such as a duration over which to perform the first optical test, a power at which to perform the first optical test, and/or other testing parameters. The user input(s) may be received as, for example, a touch or tap on a touch screen, a mouse click, a verbal input, or any other type of input(s) indicating selection of the first optical test and the first optical transport system.

In response to receiving the one or more user inputs, at operation 308, the optical testing system connects, using an optical cross-connect (e.g., optical cross-connect 108), a first optical test set with the first optical transport system. The first optical test set may be configured to execute the selected first optical test. For example, in response to receiving the inputs, the remote computing device (e.g., computing device 102) or a test manager (e.g., test manager 114) sends an instruction to the optical cross-connect to cause the optical cross-connect to connect the first optical test set with the first optical transport system.

At operation 310, the optical test system causes the first optical test set to execute the first optical test. For example, a remote computing device (e.g., computing device 102) or a test manager (e.g., test manager 114) sends an instruction to the first optical test set to cause the first optical test set to execute the first optical test.

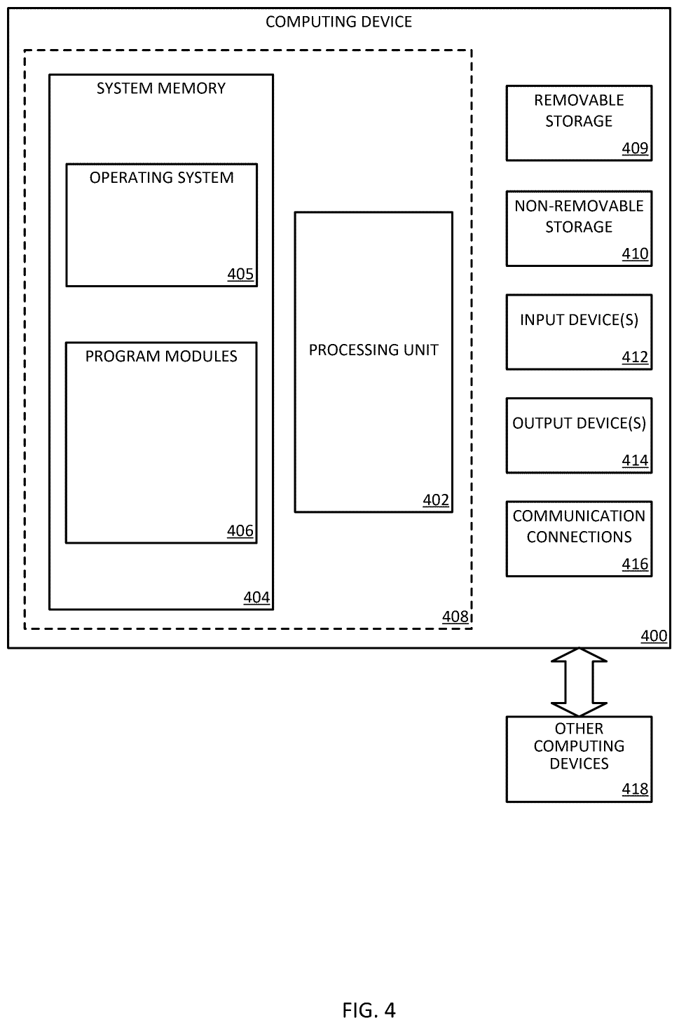

FIG. 4 is a block diagram illustrating physical components (i.e., hardware) of a computing device 400 with which examples of the present disclosure may be practiced. The computing device components described below may be suitable for a computing device(s) implementing (or included in) the computing device 102, optical test set 106, optical cross-connect 108, optical transport system 110, inventory 112, and/or test manager 114 of FIG. 1. In a basic configuration, the computing device 400 may include at least one processing unit 402 and a system memory 404. The processing unit(s) (e.g., processors) may be referred to as a processing system. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450 to implement one or more of the components or systems described above with respect to FIG. 1.

The operating system 405, for example, may be suitable for controlling the operation of the computing device 400. Furthermore, aspects of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the operations of the methods illustrated in FIGS. 2-3. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 400 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400 and/or coupled with computing device 400. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed:

1. A system for remotely testing multiple optical transport systems, the system comprising:
a first optical test set, communicatively connected to an Internet Protocol (IP) network and comprising:
a first light source;
a first optical power measurement system;
a first processing unit; and
first memory, operatively connected to the first processing unit and storing instructions that, when executed by the first processing unit, cause the first optical test set to execute a first optical test;
a second optical test set, communicatively connected to the IP network and comprising:
a second light source;
a second optical power measurement system;
a second processing unit; and
second memory, operatively connected to the second processing unit and storing instructions that, when executed by the second processing unit, cause the second optical test set to execute a second optical test;
an optical cross-connect device coupled with the first optical test set, the second optical test set, a first optical transport system, and a second optical transport system, wherein the optical cross-connect, the first optical transport system, and the second optical transport system are communicatively connected to the IP network;
a test manager, communicatively connected to the IP network and comprising:
a third processing unit; and
third memory, operatively connected to the third processing unit and storing instructions that, when executed by the third processing unit, cause the test manager to:
receive, via the IP network from a computing device, a request to execute the first optical test on the first optical transport system using the first optical test set; and
in response to receiving the request:
cause the optical cross-connect device to connect the first optical test set with the first optical transport system, and
cause the first optical test set to execute the first optical test.

2. The system of claim 1, wherein the third processing unit is further configured to:
receive, from the first optical test set, a result of the first optical test; and
provide the result to the computing device.

3. The system of claim 1, wherein the third processing unit is further configured to:
detect a completion of the first optical test; and
in response to detecting the completion of the first optical test:
obtain, from the first optical transport system, an alarm notification associated with the first optical test, and
provide the alarm notification to the computing device.

4. The system of claim 1, wherein the third processing unit is further configured to:
receive, via the IP network from the computing device, a second request to execute the second optical test on the second optical transport system using the second optical test set;
in response to receiving the second request, identify a status of the second optical test set;
in response to determining, based on the status, that the second optical test set is available:
cause the optical cross-connect device to connect the second optical test set with the second optical transport system, and
cause the second optical test set to execute the second optical test; and
in response to determining, based on the status, that the second optical test set is unavailable,
delay causing the optical cross-connect device to connect the second optical test set with the second optical transport system until the second optical test set is available.

5. The system of claim 4, wherein the third processing unit is further configured to:
in response to determining that the second optical test set is unavailable, identify a completion time of the second optical test based on a duration associated with the second optical test;
detect that the completion time has arrived; and
in response to detecting that the completion time has arrived:
cause the optical cross-connect device to connect the first optical test set with the second optical transport system, and
cause the first optical test set to execute the first optical test.

6. The system of claim 5, wherein identifying the completion time comprises obtaining the completion time from an inventory of optical test sets based on an identifier of the first optical test.

7. The system of claim 4, wherein the third processing unit is further configured to:
in response to determining that the second optical test set is unavailable, monitor the second optical test set for a completion of the optical test;
detect the completion of the second optical test; and
in response to detecting that the completion of the second optical test:
cause the optical cross-connect device to connect the second optical test set with the second optical transport system, and
cause the second optical test set to execute the second optical test.

8. The system of claim 4, wherein detecting the completion of the first optical test comprises receiving, from the second optical test set, a result of the second optical test.

9. The system of claim 1, wherein the third processing unit is further configured to:
in response to detecting the completion of the first optical test, update a status of the first test set in an inventory to indicate that the first optical test set is available.

10. The system of claim 1, wherein the third processing unit is further configured to:
in response to causing the first optical test set to execute the first optical test, updating a status of the first optical test set in the inventory to indicate that the first optical test set is in use.

11. A method, comprising:
receiving, via an Internet protocol (IP) network from a remote computing device, a request to execute a first optical test on a first optical transport system using a first optical test set; and
in response to receiving the request:
causing an optical cross-connect device to connect the first optical test set with the first optical transport system, and
causing the first optical test set to execute the first optical test;
receiving, from the first optical test set, a result of the first optical test; and
providing the result to the remote computing device.

12. The method of claim 11, further comprising:
detecting a completion of the first optical test; and
in response to detecting the completion of the first optical test:
obtaining, from the optical transport system, an alarm notification associated with the first optical test, and
providing the alarm notification to the computing device.

13. The method of claim 11, further comprising:
receiving, via the IP network from a computing device, a second request to execute a second optical test on a second optical transport system using the second optical test set;
in response to receiving the second request, identifying a status of the second optical test set;
in response to determining, based on the status, that the second optical test set is available:
causing the optical cross-connect device to connect the second optical test set with the second optical transport system, and
causing the second optical test set to execute the second optical test; and
in response to determining, based on the status, that the second optical test set is unavailable,
delaying causing the optical cross-connect device to connect the second optical test set with the second optical transport system until the second optical test set is available.

14. The method of claim 13, further comprising:
in response to determining that the second optical test set is unavailable, identifying a completion time of the second optical test based on a duration associated with the second optical test;
detecting that the completion time has arrived; and
in response to detecting that the completion time has arrived:
causing the optical cross-connect device to connect the second optical test set with the second optical transport system, and
causing the second optical test set to execute the second optical test.

15. The method of claim 14, wherein identifying the completion time comprises obtaining the completion time from an inventory of optical test sets based on an identifier of the second optical test set.

16. The method of claim 13, further comprising:
in response to determining that the second optical test set is unavailable, monitoring the second optical test set for a completion of the second optical test;
detecting the completion of the second optical test; and
in response to detecting that the completion of the second optical test:
causing the optical cross-connect device to connect the second optical test set with the second optical transport system, and
causing the second test set to execute the second optical test.

17. The method of claim 15, wherein detecting the completion of the second optical test comprises receiving, from the second optical test set, a result of the second optical test.

18. A system, comprising:
at least one processor; and
a memory including instructions, which when executed by the at least one processor, cause the system to:
obtain, from an inventory, a list of optical tests and a list of optical transport systems;
display, via a computing device, the list of optical tests and the list of optical transport systems;
receive, via the computing device, one or more user inputs indicating selection of a first optical test of the list of optical tests and a first optical transport system of the list of optical transport systems;
connect, using an optical cross-connect device and in response to receiving the one or more user inputs, a first optical test set with the first optical transport system; and
cause the first optical test set to execute the first optical test.

19. The system of claim 18, wherein the instructions further cause the system to:
receive, via the computing device, one or more second user inputs indicating selection of a second optical test of the list of optical tests and a second optical transport system of the list of optical transport systems;
connect, using the optical cross-connect device and in response to receiving the one or more second user inputs, a second optical test set with the second optical transport system; and
cause the second optical test set to execute the second optical test.

20. The system of claim 18, wherein the instructions further cause the system to:
detect the completion of the first optical test; and
in response to detecting the completion of the first optical test:
update a status of the first optical test set in the inventory to indicate that the first optical test set is available,
obtain, from the first optical transport system, a first result of the first optical test generated by the first optical transport system during the first optical test,
obtain, from the first optical test set, a second result of the first optical test, and
provide, to the computing device, the first result and the second result.
